(19) United States
(12) Patent Application Publication
(10) Pub. No.: US 2008/0023162 A1
(43) Pub. Date: Jan. 31, 2008

(54) Dissolution Method

(75) Inventors: Vesa Myllymaki, Vatakuja (FI); Reijo Aksela, Soukan Rannantie (FI)

Correspondence Address: BIRCH STEWART KOLASCH & BIRCH, PO BOX 747, FALLS CHURCH, VA, 22040-0747, US

(73) Assignee: KEMIRA OYJ, Helsinki (FI)

(21) Appl. No.: 10/568,458

(22) PCT Filed: Aug. 13, 2004
(86) PCT No.: PCT/FI04/00476

§ 371 Date: Jan. 4, 2007

(30) Foreign Application Priority Data
Aug. 15, 2003 (FI) 20031156

(51) Int. Cl. C08J 3/09; C08J 3/28; D21C 3/20

(52) U.S. Cl. 162/163; 162/192

(57) ABSTRACT

The invention relates to a method for dissolving wood, straw and other natural lignocellulosic materials in an ionic liquid solvent under microwave irradiation and/or under pressure. The invention also relates to the resulting solution and to methods for separating cellulose and other organic compounds, such as lignin and extractives, from the solution.

### FIELD OF THE INVENTION

The present invention is directed to a method for dissolving wood, straw and other natural lignocellulosic materials, and to the resulting solution, as well as to methods for separating cellulose and other organic compounds, such as lignin and extractives, from the resulting solution.

### BACKGROUND ART

Pulp

Pulp obtained from plant fiber is the raw material for the production of paper, paperboard, fiberboard, and other similarly manufactured products. In its purified form, it is a source of cellulose for rayon, cellulose esters and other cellulose derived products.

Wood is the primary source of fiber for pulp. Other sources include straws, grasses and canes. Pulp fibers can principally be extracted from any vacular plant found in nature, also from nonwood sources such as straws and grasses, eg, rice, esparto, wheat, and sabai; canes and reeds, eg, primarily bagasses or sucar cane; several varieties of bamboo; bast fibers, eg, jute, flax, kenaf, linen, ramie, and cannabis; leaf fibers, eg, abaca or manila hemp and sisal.

The chemical components found in wood fall into two categories: low molecular weight substances and macromolecular substances. The macromolecular substances account for about 90 to 99% of the wood material. About 65 to 75% of the macromolecular substanses consists of polysaccharides, mainly cellulose and hemicellulose, the remainder being lignin. Cellulose is the main component of the wood material. The basic structural element of the cell wall is cellulose. Lignin and hemicelluloses are distributed throughout the cell wall in an incompletely understood manner. The intercellular substance, which is pimarly lignin, must be softened or dissolved to free individual fibers. Wood also contains about 3 to 10% of extracellular, low molecular weight constituents, many of which can be extracted from the wood using neutral solvents and therefore are commonly called extractives including fats, fatty esters, terpenes, resin acids etc. (Kirk-Othmer, Encyclopedia of Chemical Technology, 1996, 4th Ed., Vol. 20, p. 493-498).

Wood as a source of pulp is divided into softwoods or evergreens, which are gymnosperms, and hardwoods or broad-leaved trees, which are dicotyledon angiosperms. The softwood, which are preferred for most pulp products because of their longer fibers, generally contain a higher (26-32% on an extractives-free basis) percentage of lignin and a lower (14-17%) percentage of hemicellulose than the hardwoods. The latter contain 17-26% lignin and 18-27% hemicellulose. Lignin is a highly branched alkylaromatic thermoplastic polymer, and is incompletely characterized.

Wood Pulping Processes

The principal wood-pulping processes in use as of mid-1990s are stone groundwood, soda, SO₂ or acid sulfite, and sulfate or kraft processes, developed in 1844, 1853, 1866 and 1870, respectively (Kirk-Othmer, Encyclopedia of Chemical Technology, 1996, 4th Ed., Vol. 20, p. 493-546). Since then, the basic processes have been modified numerous times. However, the scientific base for this technology is considerably slower in development, largely because of the physical and chemical heterogeneneity of wood and the complexity of its component polymers and their interaction.

Pulp fibers are classified according to the method of manufacture as mechanical, chemical, chemimechanical and semichemical.

In mechanical pulping the wood structure is heavily disrupted into fragments of variable dimensions by mechanical treatment. A rough classification of the pulp according to particle size gives three main types of material: fines, fibers and fiber bundles (chives). The yield is somewhat dropped due to chemical pretreatment of wood, the magnitude of which depends on the severity of treatment. Chemithermomechanical pulp (CTMP) is obtained by a comparatively mild chemical treatment followed by pressurized refining. If a stronger chemical treatment is applied at an elevated temperature, chemimechanical pulp (CMP) is obtained.

Properties of mechanical pulp vary significantly. Generally, refiner mechanical pulps (RMP) and thermomaechanical pulps (TMP) have a smaller content of fine material and the long fibers tend to be more ribbon-like. Chemithermomechanical (CTMP) and chemimechanical (CMP) pulps generally have higher quantities of long fibers and less fines than TMP and RMP.

When processing chemical pulps, the process normally involves wood and liquour preparation steps, delignification (pulping), pulp washing, knot and shive (fiber bundles) removal, screening, cleaning, thickening, and, in case of the bleachable grades, residual lignin removal and brightening to eliminate chromophoric or light absorbing groups.

In chemical pulps, sufficient amount of lignin is dissolved from the middle lamella to allow the fibers to separate, using little or no mechanical action. However, a portion of the cell wall lignin is retained in the fiber, and attempts to remove this during digestion can result in excessive degradation of the pulp. The residual lignin is therefore subsequently removed by bleaching in separate processing if completely delignified pulps are to be produced.

The most important chemical wood pulping process is the kraft or sulfate process. In this, the alkaline pulping liquor or digesting solution contains about a three-to-one ratio of sodium hydroxide (NaOH) and sodium sulfide Na₂S. The alternative term, ie, the sulfate process, is derived from the use of sodium sulfate, Na₂SO₄, as a makeup chemical in the recovery process. Sodium sulfate is reduced to sodium sulfide in the recovery furnace by reaction with carbon black liquor (Kirk-Othmer, Encyclopedia of Chemical Technology, 1996, 4th Ed., Vol. 20, p. 493-546).

Tall Oil Separation

Crude tall oil (CTO) is a dark oily liquid with 26-42% resin acids or rosin, 36-48% fatty acids, and 10-38% neutrals. CTO is a very important source of oleic/linoleic fatty acids and resin acids or rosin (Kirk-Othmer, Encyclopedia of Chemical Technology, 1997, 4th Ed., Vol. 23, p. 616-622).

As known, the present kraft pulping process yields strong cellulose fibers by digesting pinewood chips for about two hours with an aqueous mixture of sodium hydroxide and sodium sulfide at 165-175° C. under pressure. After filtration of fibers, pulping black liquour must be concentrated by multistage evaporation. At this stage, the tall oil is in soap form and must be converted into CTO by neutralizing with sulfuric acid. The proceeding is then followed by fractional distillation to separate rosin, and fatty acids and purification of the fatty acid fraction.

Only approximately 45% of CTO available in the pine tree is recovered. The rest is lost during woodyard operations (20%), pulping (15%), black liquor recovery (15%), and finally in acidulation (5%). To improve the yield, several processing changes in the limits of this conventional approach have been proposed (Kirk-Othmer, Encyclopedia of Chemical Technology, 1997, 4th Ed., Vol. 23, p. 616-622).

Dissolution of Cellulose

U.S. Pat. No. 1,943,176 discloses a process for the preparation of solutions of cellulose by dissolving cellulose under heating in a liquefied N-alkylpyridinium or N-benzylpyridinium chloride salt, preferably in the presence of an anhydrous nitrogen-containing base, such as pyridine. These salts are known as ionic liquids. The cellulose to be dissolved is preferably in the form of regenerated cellulose or bleached cellulose or linter. According to U.S. Pat. No. 1,943,176 the cellulose solutions are suitable for various chemical reactions, such as esterification. U.S. Pat. No. 1,943,176 also suggests separating cellulose from the cellulose solution by means of suitable precipitating agents, such as water or alcohol to produce for example cellulose threads or films or masses.

Also other cellulose solvents are known. For example, viscose rayon is prepared from cellulose xanthate utilizing carbon disulfide as both reagent and solvent. U.S. Pat. No. 3,447,939 discloses dissolving natural or synthetic polymeric compounds, such as cellulose in a cyclic mono(N-methylamine-N-oxide), especially N-methylmorpholine-N-oxide.

WO 03/029329 discloses a dissolution method very similar to the one disclosed in U.S. Pat. No. 1,943,176. The main improvement resides in the application of microwave radiation to assist in dissolution. The cellulose to be dissolved is fibrous cellulose, wood pulp, linters, cotton balls or paper, i.e. cellulose in a highly pure form. The inventors of WO 03/029329 have published an article (Swatloski, R. P.; Spear S. K.; Holbrey, J. D.; Rogers, R. D. Journal of American Chemical Society, 2002, 124, p. 4974-4975) focused on the dissolution of cellulose with ionic liquids, especially 1-butyl-3-methyl-imidazolium chloride, by heating in a microwave oven. The cellulose used in the dissolution experiments was dissolving pulp (from cellulose acetate, lyocell, and rayon production lines), fibrous cellulose and filter paper, i.e. cellulose in a highly pure form that does not contain any significant amounts of lignin. This article also teaches precipitating cellulose from the ionic liquid solution by the addition of addition of water or other precipitating solutions including ethanol and acetone.

Ionic Liquids

The literature knows many synonyms used for ionic liquids. Up to date, “molten salts” is maybe the most broadly applied term for ionic compounds in the liquid state. There is a difference between molten salts and ionic liquids, however. Ionic liquids are salts that are liquid around room temperature (typically −100° C. to 200° C., but this might even exceed 300° C.) (Wassercheid, P.; Welton, T. Ionic Liquids in Synthesis 2003, WILEY-VCH, p. 1-6, 41-55 and 68-81). Therefore, the term RTIL (room temperature ionic liquids) is commonly applied for these solvents.

RTILs are non-flammable, non-volatile and they possess high thermal stabilities. Typically, these solvents are organic salts or mixtures consisting of at least one organic component. By changing the nature of the ions present in an RTIL, it is possible to change the resulting properties of the RTILs. The lipohilicity of an ionic liquid of a RTIL is easily modified by the degree of cation substitution. Similarly, the miscibility with for example water can be tuned from complete miscibility to almost total immiscibility, by changing the anion from, for example, CI- to [PF₆]⁻.

All these variations in cations and anions can produce a very large range of ionic liquids allowing the fine-tuning for specific applications. Furthermore, the RTILs are relatively cheap and easy to manufacture. They can also be reused after regeneration.

Microwaves

It is known from the recent literature concerning organic synthesis that the reaction times of organic reactions are remarkable reduced when the energy necessary for the occurrence of the reaction is introduced to the system by using microwave irradiation. The commonly used frequency for microwave energy is 2.45 GHz. There is a wide and continuously increasing literature available in the area of using microwave techniques in organic synthesis. An example of a short summary article of this topic was published by Mingos in 1994 (D. Michael P. Mingos; “Microwaves in chemical synthesis” in Chemistry and industry, 1. August 1994, pp. 596-599). Loupy et. al. have recently published a review concerning heterogenous catalysis under microwave irradiation (Loupy, A., Petit, A., Hamelin, J., Texier-Boullet, F., Jachault, P., Mathe, D.; “New solvent-free organic synthesis using focused microwave” in Synthesis 1998, pp. 1213-1234). Another representative article of the area is published by Strauss as an invited review article (C. R. Strauss;

“A combinatorial approach to the development of Environmentally Benign Organic Chemical Preparations”, Aust. J. Chem. 1999, 52, pp. 83-96).

Because of their ionic nature, ionic liquids are excellent media for utilizing microwave techniques. Rogers et al. published in 2002 a method for dissolution of pure cellulose fibers into ionic liquids in the microwave field (Swatloski, R. P.; Spear S. K.; Holbrey, J. D.; Rogers, R. D. Journal of American Chemical Society, 2002, 124, p. 4974-4975). Furthermore, they were able to precipitate the fibers back by mixing this fiber-containing solution with water.

### SUMMARY OF THE INVENTION

It is an object of this invention to provide a method for dissolving wood and other lignocellulosic materials.

Another object of the invention is to provide a complete or substantially complete delignification of lignocellulosic materials.

A further object is to provide a solution of lignocellulosic materials.

Further objects will become apparent from the following description and claims.

The present invention is based on the surprising discovery that untreated wood, straw and other natural lignocellulosic materials can be dissolved into ionic liquids assisted with microvawes and/or pressure. Surprisingly, the trial to dissolve soft wood into an ionic liquid (BMIMCI) proved successful.

The present invention opens new possibilities for wood processing. Thus, for example the delignification of wood or straw or other natural lignocellulosic fiber sources by dissolution accomplishes a possibility to total delignification in a single step. Furthermore, the invention makes it possible to precipitate fibers as well as other wood or straw etc. derived organic compounds from the solution. It also accomplishes the distillation and extraction of volatile wood and straw etc. composites.

Although it was known on the basis of the above discussed prior art to dissolve pure cellulose (derived from wood wherein the wood structure is disrupted) in ionic liquids, the present discovery that untreated wood wherein the wood structure including the cell wall structure is intact, can be dissolved in ionic liquids, was unexpected.

### DETAILED DESCRIPTION OF THE INVENTION

In one aspect of the invention there is provided a method for dissolving lignocellulosic material comprising mixing the lignocellulosic material with an ionic liquid solvent under microwave irradiation and/or under pressure in the substantial absence of water to completely dissolve the lignocellulosic material.

In a preferred embodiment microwave irradiation is applied to assist in dissolution.

It is also possible to apply pressure to assist in dissolution. The pressure is preferably below 2.0 MPa, more preferably below 1.0 MPa and most preferably between 0.2 MPa and 0.9 MPa.

The dissolution of the lignocellulosic material can be carried out at a temperature between 0° C. and 250° C., preferably at a temperature between 20° C. and 200° C. and more preferably at a temperature between 50° C. and 170° C., such as between 80° C. and 150° C. The heating can be carried out by microwave irradiation.

The solution is agitated until complete dissolution is obtained.

In the dissolution no auxiliary organic solvents or co-solvents, such as nitrogen-containing bases, e.g. pyridine disclosed in U.S. Pat. No. 1,943,176, are necessary. Preferably such solvents are omitted.

The ionic liquid solvent is molten at a temperature between −100° C. and 200° C., preferably at a temperature of below 170° C., and more preferably between −50° C. and 120° C.

The cation of the ionic liquid solvent in preferably a five- or six-membered heterocyclic ring optionally being fused with a benzene ring and comprising as heteroatoms one or more nitrogen, oxygen or sulfur atoms. The heterocyclic ring can be aromatic or saturated. The cation can be one of the following:

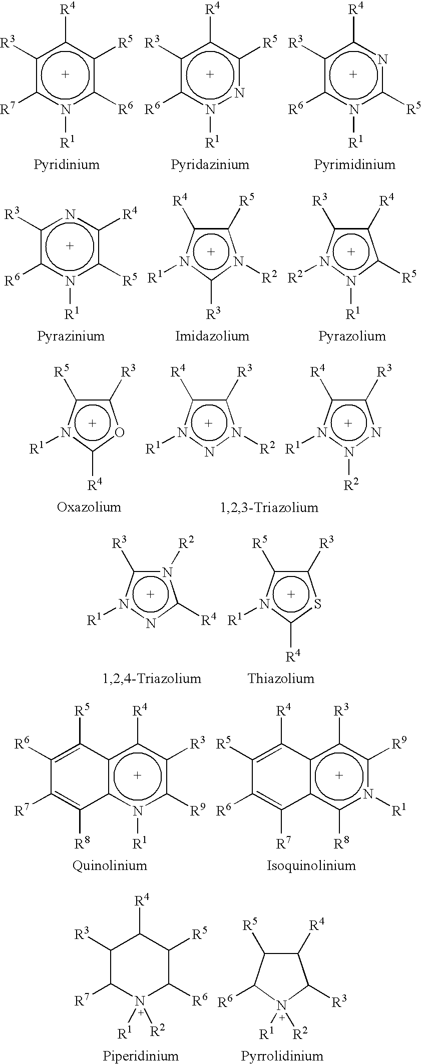

wherein R¹ and R² are independently a C₁-C₆ alkyl or C₂-C₆ alkoxyalkyl group, and R³, R⁴, R⁵, R⁶, R⁷, R⁸ and R⁹ are independently hydrogen, a C₁-C₆ alkyl, C₂-C₆ alkoxyalkyl or C₁-C₆ alkoxy group.

In the above formulae R¹ and R² are preferably both C₁-C₄ alkyl, and R³-R⁹, when present, are preferably hydrogen.

C₁-C₆ alkyl includes methyl, ethyl, propyl, iso-propyl, butyl, sec-butyl, tert-butyl, pentyl, the isomers of pentyl, hexyl and the isomers of hexyl.

C₁-C₆ alkoxy contains the above C₁-C₆ alkyl bonded to an oxygen atom.

C₂-C₆ alkoxyalkyl is an alkyl group substituted by an alkoxy group, the total number of carbon atoms being from two to six.

Preferred cations have following formulae:

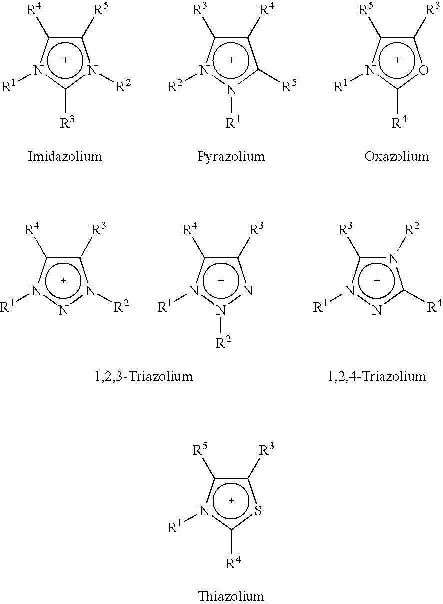

wherein R¹-R⁵ are as defined above.

An especially preferred cation is the imidazolium cation having the formula:

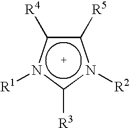

wherein R¹-R⁵ are as defined above. In this formula R³-R⁵ are preferably each hydrogen and R¹ and R² are independently C₁-C₆ alkyl or C₂-C₆ alkoxyalkyl. More preferably one of R¹ and R² is methyl and the other is C₁-C₆ alkyl.

The anion of the ionic liquid solvent can be halogen such as chloride, bromide or iodide;

pseudohalogen such as thiocyanate or cyanate;

perchlorate;

C₁-C₆ carboxylate such as formate, acetate, propionate, butyrate, lactate, pyruvate, maleate, fumarate or oxalate;

nitrate;

C₂-C₆ carboxylate substituted by one or more halogen atoms such as trifluoroacetic acid;

C₁-C₆ alkyl sulfonate substituted by one or more halogen atoms such as trifluoromethane sulfonate (triflate);

tetrafluoroborate BF₄⁻; or

phosphorus hexafluoride PF₆⁻.

The above halogen substituents are preferably fluoro.

The anion of the ionic liquid solvent is preferably selected among those providing a hydrophilic ionic liquid solvent. Such anions include halogen, pseudohalogen or C₁-C₆ carboxylate. The halogen is preferably chloride, bromide or iodide, and the pseudohalogen is preferably thiocyanate or cyanate.

If the cation is a 1-(C₁-C₆-alkyl)-3-methyl-imidazolium, the anion is preferably a halogenid, especially chloride.

The melting point for the preferred ionic liquid solvent 1-butyl-3-methyl-imidazolium chloride (BMIMCI) is about 60° C.

The term “lignocellulosic material” as used in this specification means a natural material containing cellulose and lignin that has not been subjected to a pulping or defibering process. Thus, chemical and mechanical pulps and the like are not included in said term.

The lignocellulosic material is preferably native wood that has not been subjected to any chemical or mechanical pulping process. Besides wood also other native lignocellulosic materials can be used, such as straw.

The lignocellulosic material is prior to the dissolution reduced to a desired size and form, e.g. to small chips, and, if necessary, dried.

The phrase “in the substantial absence of water” means that not more than a few percent by weight water is present is the dissolution. Preferably, the water content is less that 1 percent by weight.

In another aspect of the invention there is provided a solution comprising dissolved lignocellulosic material in an ionic liquid solvent that is substantially free of water.

The ionic liquid solvent and the lignocellulosic material are as defined above.

The lignocellulosic material can be present in an amount of about 1% to 30% by weight of the solution. Preferably the amount is about 10% to 20%.

In a further aspect of the invention there is provided a method for separating cellulose from a lignocellulosic material comprising mixing the lignocellulosic material with an ionic liquid solvent under microwave irradiation and/or under pressure in the substantial absence of water to completely dissolve the lignocellulosic material, thereby obtaining a solution of the lignocellulosic material, and thereafter precipitating the cellulose by adding a non-solvent for the cellulose.

The ionic liquid solvent and the lignocellulosic material are as defined above.

According to an embodiment of this method the lignin is removed from said solution before precipitating the cellulose.

Said non-solvent is a liquid that is miscible with the ionic liquid solvent and includes water, an alcohol, a ketone, acetonitrile or an ether. The alcohol can for example be methanol or ethanol. The ketone can for example be acetone. The ether can for example be furan or dioxane. The non-solvent is preferably water, an alcohol or a ketone.

After the separation of the precipitated cellulose, the non-solvent can be separated from the ionic liquid solvent, for example by distilling or drying in case water is used as the non-solvent. Thereafter the ionic liquid solvent can be reused.

In a still further aspect of the invention there is provided a method for the delignification of a lignocellulosic material comprising mixing the lignocellulosic material with an ionic liquid solvent under microwave irradiation and/or under pressure in the substantial absence of water to completely dissolve the lignocellulosic material, thereby obtaining a solution of the lignocellulosic material, and thereafter subjecting the solution to extraction to separate lignin from the solution.

The ionic liquid solvent and the lignocellulosic material are as defined above.

The invention additionally provides a method for the separation of extractives or a component thereof from a lignocellulosic material comprising mixing the lignocellulosic material with an ionic liquid solvent under microwave irradiation and/or under pressure in the substantial absence of water to completely dissolve the lignocellulosic material, thereby obtaining a solution of the lignocellulosic material, and thereafter separating the extractives or a component thereof from said solution.

The ionic liquid solvent and the lignocellulosic material are as defined above.

Typical extractives to be separated by this method includes fats, fatty esters, terpenes and resin acids.

The extractives or a component thereof can be separated from the solution by extraction or by distillation.

As the present invention has made it possible to dissolve wood, straw etc. into an ionic liquid solvent, the basic consept of the invention can be applied e.g. for
the complete delignification of wood, straw etc., thereby remarkably simplifying the bleaching sequences
separation of lignin and tall oil/extractives as pure fractions
precipitation of fibers from the solution
precipitation of wood, straw etc. derived organic compounds from the solution
extraction or distillation of volatile wood, straw etc. components from the solution
production of long fibers due to simple and mild treatment
processing of wood with a minimal use of water
environmentally benign techniques especially as the ionic liquids can be reused.

The percentages in this specification refer to % by weight unless otherwise specified.

### EXAMPLES

### Example 1

Dissolution of Plywood Sawdust

50 mg of plywood sawdust was mixed with an ionic liquid (BMIMCI, 5 g, melting point 60° C.) in 1% solution. The resulting mixture was heated by microwaves in a MW reactor designed for organic synthesis in 10 min sequences at temperatures ranging from 80 to 150° C. Partial dissolution could be detected.

The resulting solution after the experiment was partly cloudy. The cloudiness resulted from the adhesives present in the plywood.

### Example 2

Dissolution of Softwood

112 mg of small chips of Finnish softwood were mixed with an ionic liquid (BMIMCI, 5 g, melting point 60° C.). The resulting mixture was heated by microwaves in a MW reactor designed for organic synthesis in 10 min sequences at temperatures ranging from 80 to 150° C.

After 10 min at 80° C., the dissolution of the wood was visible. The outer layers of wood sticks became transparent and small fibers appeared on the surface of the sticks. The heating was continued in 10 min sequences at 100° C. for one hour. The wood sticks were gradually dissolved into solution. While decreasing in size, the sticks gradually lost their woodlike structure and became more like a bunch of fibers gradually dissolving into solution. After heating one hour at 150° C. even the still remaining small quantity of undissolved material was completely dissolved resulting in an amber coloured, transparent and viscous solution.

The ionic liquid having initial melting point at 60° C., remained as a viscous solution at room temperature.

### Example 3

Dissolution of Straw, 1% Solution

50 mg of straw was mixed with an ionic liquid (BMIMCI, 5 g, melting point 60° C.) in 1% solution. The resulting mixture was heated by microwaves in a MW reactor designed for organic synthesis for 10 minutes at 170° C. Full dissolution could be detected resulting in a darkish, amber coloured, transparent and viscous solution.

### Example 4

Dissolution of Straw, 2% Solution

100 mg of straw was mixed with an ionic liquid (BMIMCI, 5 g, melting point 60° C.) in 2% solution. The resulting mixture was heated by microwaves in a MW reactor designed for organic synthesis for 10 minutes at 170° C. Full dissolution could be detected resulting in a darkcoloured, transparent and viscous solution. The viscosity increased somewhat compared to 1% solution in example 3.

1. A method for dissolving lignocellulosic material comprising mixing the lignocellulosic material with an ionic liquid solvent under microwave irradiation and/or under pressure in the substantial absence of water to completely dissolve the lignocellulosic material.

2. The method according to claim 1 wherein microwave irradiation is applied to assist in dissolution.

3. The method according to claim 1 wherein pressure is applied to assist in dissolution.

4. The method according to claim 1 wherein the ionic liquid solvent is molten at a temperature of below 200° C.

5. The method according to claim 1 wherein the cation of the ionic liquid solvent is selected from the group consisting of 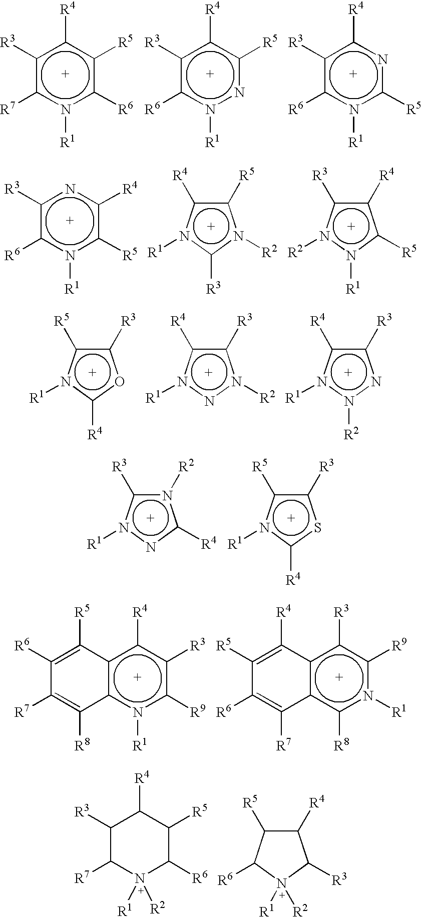
wherein R¹ and R² are independently a C₁-C₆ alkyl or C₂-C₆ alkoxyalkyl group, and R³, R⁴, R⁵, R⁶, R⁷, R⁸ and R⁹ are independently hydrogen, a C₁-C₆ alkyl, C₂-C₆ alkoxyalkyl or C₁-C₆ alkoxy group, and
wherein the anion of the ionic liquid solvent is halogen, pseudohalogen or C₁-C₆ carboxylate.

6. The method according to claim 5 wherein said cation comprises 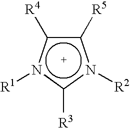
wherein R³-R⁵ are hydrogen and R¹ and R² are the same or different and represent C₁-C₆ alkyl, and said anion is halogen, preferably chloride.

7. The method according to claim 1 wherein the lignocellulosic material is a material that has not been subjected to a pulping or defibering process.

8. The method according to claim 7 wherein the lignocellulosic material is untreated wood, such as softwood or hardwood, or untreated straw.

9. A solution comprising dissolved lignocellulosic material in an ionic liquid solvent that is substantially free of water.

10. The solution of claim 9 wherein the lignocellulosic material is present in an amount of about 1% to 30% by weight of the solution.

11. The solution according to claim 9 wherein the cation of the ionic liquid solvent is selected from the group consisting of 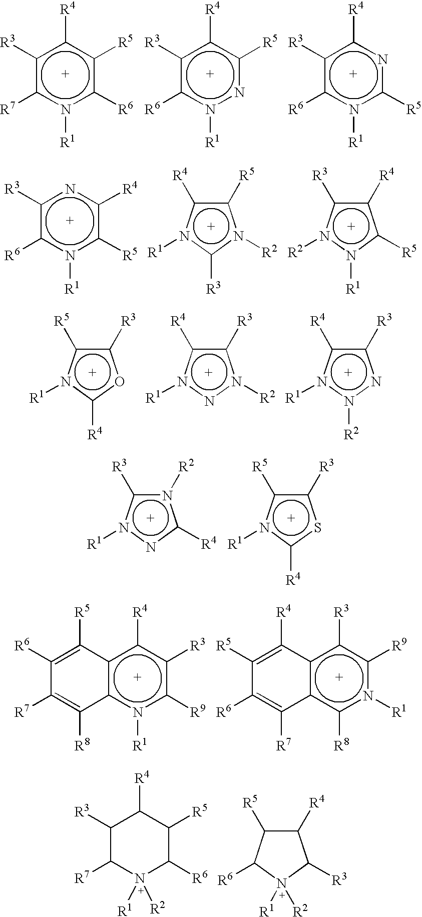
wherein R¹ and R² are independently a C₁-C₆ alkyl or C₂-C₆ alkoxyalkyl group, and R³, R⁴, R⁵, R⁶, R⁷, R⁸ and R⁹ are independently hydrogen, a C₁-C₆ alkyl, C₂-C₆ alkoxyalkyl or C₁-C₆ alkoxy group, and
wherein the anion of the ionic liquid solvent is halogen, pseudohalogen or C₁-C₆ carboxylate.

12. A method for separating cellulose from a lignocellulosic material comprising mixing the lignocellulosic material with an ionic liquid solvent under microwave irradiation and/or under pressure in the substantial absence of water to completely dissolve the lignocellulosic material, thereby obtaining a solution of the lignocellulosic material, and thereafter precipitating the cellulose by adding a non-solvent for the cellulose.

13. The method according to claim 12 wherein the lignin is removed from said solution before precipitating the cellulose.

14. The method according to claim 12 wherein said non-solvent for the ionic liquid solvent is water, an alcohol, a ketone or an ether.

15. The method according to claim 12 wherein the cation of the ionic liquid solvent is selected from the group consisting of 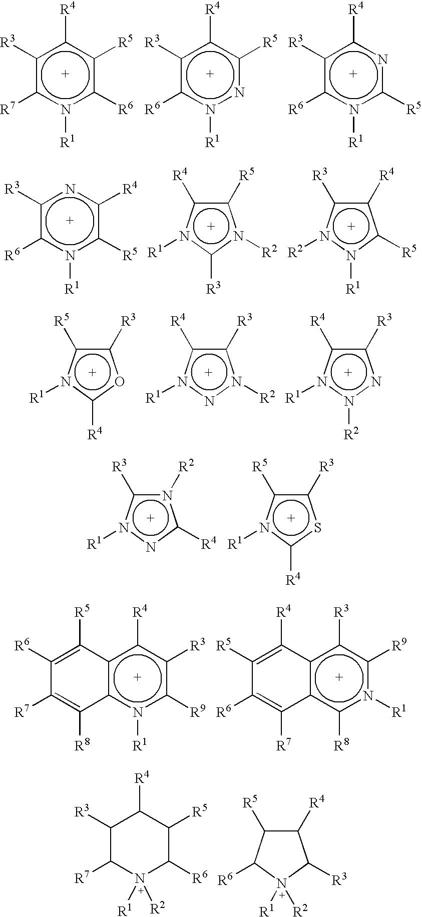
wherein R¹ and R² are independently a C₁-C₆ alkyl or C₂-C₆ alkoxyalkyl group, and R³, R⁴, R⁵, R⁶, R⁷, R⁸ and R⁹ are independently hydrogen, a C₁-C₆ alkyl, C₂-C₆ alkoxyalkyl or C₁-C₆ alkoxy group, and
wherein the anion of the ionic liquid solvent is halogen, pseudohalogen or C₁-C₆ carboxylate.

16. A method for the delignification of a lignocellulosic material comprising mixing the lignocellulosic material with an ionic liquid solvent under microwave irradiation and/or under pressure in the substantial absence of water to completely dissolve the lignocellulosic material, thereby obtaining a solution of the lignocellulosic material, and thereafter subjecting the solution to extraction to separate lignin from the solution.

17. The method according to claim 16 wherein the cation of the ionic liquid solvent is selected from the group consisting of 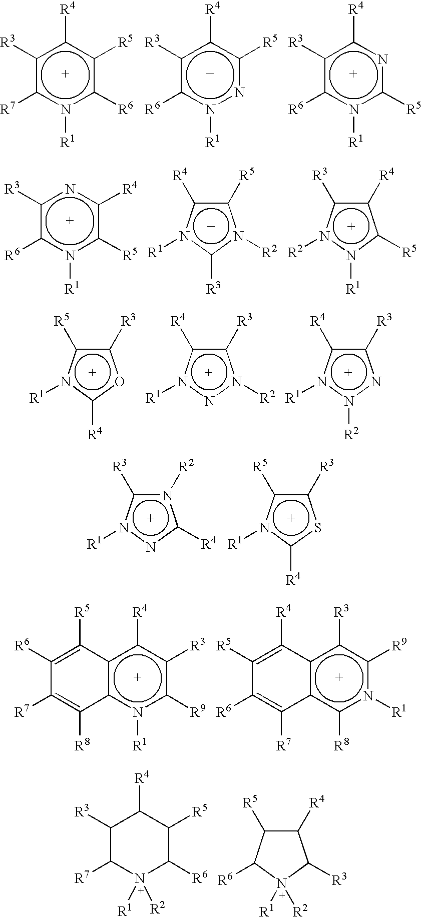
wherein R¹ and R² are independently a C₁-C₆ alkyl or C₂-C₆ alkoxyalkyl group, and R³, R⁴, R⁵, R⁶, R⁷, R⁸ and R⁹ are independently hydrogen, a C₁-C₆ alkyl, C₂-C₆ alkoxyalkyl or C₁-C₆ alkoxy group, and
wherein the anion of the ionic liquid solvent is halogen, pseudohalogen or C₁-C₆ carboxylate.

18. A method for the separation of extractives or a component thereof from a lignocellulosic material comprising mixing the lignocellulosic material with an ionic liquid solvent under microwave irradiation and/or under pressure in the substantial absence of water to completely dissolve the lignocellulosic material, thereby obtaining a solution of the lignocellulosic material, and thereafter separating the extractives or a component thereof from said solution.

19. The method according to claim 18 wherein the extractives or a component thereof are separated from said solution by extraction or by distillation.

20. The method according to claim 18 wherein the cation of the ionic liquid solvent is selected from the group consisting of 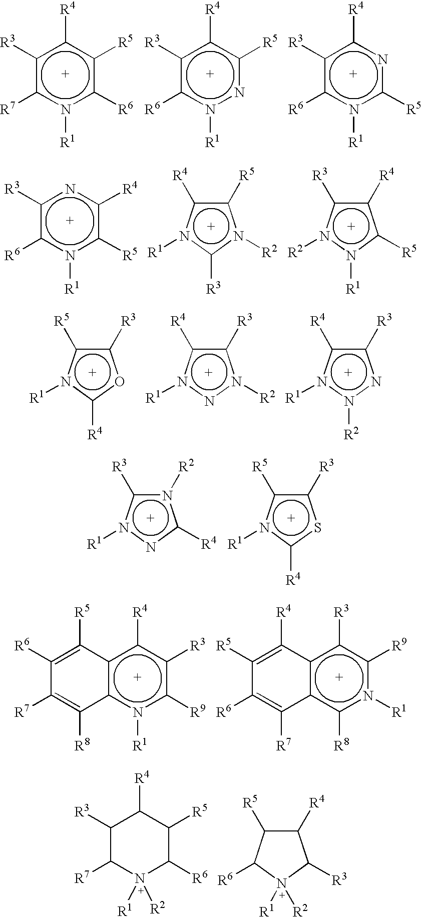
wherein R¹ and R² are independently a C₁-C₆ alkyl or C₂-C₆ alkoxyalkyl group, and R³, R⁴, R⁵, R⁶, R⁷, R⁸ and R⁹ are independently hydrogen, a C₁-C₆ alkyl, C₂-C₆ alkoxyalkyl or C₁-C₆ alkoxy group, and
wherein the anion of the ionic liquid solvent is halogen, pseudohalogen or C₁-C₆ carboxylate.
